(19) United States
(12) Patent Application Publication
(10) Pub. No.: US 2010/0296949 A1
(43) Pub. Date: Nov. 25, 2010

(54) HIGH-EFFICIENCY PNEUMATIC DRIVE MOTOR SYSTEM

(75) Inventor: Clifford CORLEY, Hampton, GA (US)

Correspondence Address: GARDNER GROFF GREENWALD & VILLANUEVA. PC, 2018 POWERS FERRY ROAD, SUITE 800, ATLANTA, GA, 30339, US

(73) Assignee: ADVANCED AIR INNOVATIONS LLC, Norcross, GA (US)

(21) Appl. No.: 12/851,698

(22) Filed: Aug. 6, 2010

Related U.S. Application Data
(60) Provisional application No. 61/232,696, filed on Aug. 10, 2009.

(51) Int. Cl. F03C 1/02; F01B 23/02; F03C 1/26

(52) U.S. Cl. 417/279; 417/384; 417/398; 60/407

(57) ABSTRACT

A fluid driven motor system including a source of pressurized drive fluid and at least one cylinder having a piston therein for reciprocating motion. The cylinder receives the pressurized drive fluid from the source, and a compressor receives drive fluid exhausted from the at least one cylinder. The pressurized drive fluid circulates in a closed loop from the compressor to the cylinder.

### CROSS-REFERENCE TO RELATED APPLICATION

This application claims the benefit of U.S. Provisional Patent Application Ser. No. 61/232,696, filed Aug. 10, 2009, the entirety of which is hereby incorporated herein by reference.

### TECHNICAL FIELD

The present invention relates generally to the field of motors, and more particularly to a pneumatic drive motor having improved energy efficiency.

### BACKGROUND

It has been posited by both the scientific community and the federal government that pollutants generated by internal combustion engines powering industry and transportation around the world are a significant contributor to greenhouse gas and pollutant emissions into the earth's atmosphere. These pollutants include but are not limited to carbon monoxide, hydrocarbons not fully combusted, and nitrogen oxides.

In addition, it is widely known that our planet has a finite supply of oil. Oil production may have peaked worldwide and significant new oil reserves are not easily discovered. As a result of this growing supply and demand imbalance, a spike in petroleum product pricing has drastically increased the cost of operation of internal combustion engines, which have traditionally been the primary driver of personal transportation vehicles, as well as electrical generators and other equipment.

Accordingly, it can be seen that needs exist for high efficiency power systems and for engines that reduce dependence on oil. It is to the provision of a power system meeting these and other needs that the present invention is primarily directed.

### SUMMARY

The present invention provides a highly efficient power system in the form of a pneumatic drive motor. The motor can be utilized to power vehicles for transportation, to generate electricity, to drive a pump, and/or for various other purposes. Air or other fluid(s) used to drive the motor can be pressurized by various means, including using clean renewable energy sources such as solar or wind power. The high-pressure drive fluid is maintained in a closed loop or circuit within the system and recirculated, thereby reducing or eliminating the necessity to input additional energy to pressurize the drive fluid.

In one aspect, the present invention relates to a fluid driven motor system, preferably including an engine having at least one reciprocating piston and an intake port for delivery of a pressurized working fluid to drive the piston. The system preferably further includes a source of the pressurized working fluid connected to the intake port of the engine, and an output of the engine driven by operation of the at least one reciprocating piston and delivering energy to the source to pressurize the pressurized working fluid.

In another aspect, the invention relates to a fluid driven motor system, preferably including an engine having at least one cylinder, a piston reciprocally mounted within each cylinder, a working fluid intake port in communication with each cylinder, and at least one power output. The system preferably further includes a compressor for pressurizing a working fluid, the compressor at least partially driven by the at least one power output of the engine. The system preferably further includes an intake manifold receiving the pressurized working fluid, a solenoid valve controlling delivery of the pressurized working fluid from the intake manifold to each cylinder, and an electric motor for driving the compressor.

In another aspect, the invention relates to a fluid driven motor system, preferably including a source of pressurized drive fluid, at least one cylinder having a piston therein for reciprocating motion, the cylinder receiving the pressurized drive fluid from the source, and a compressor receiving drive fluid exhausted from the at least one cylinder. The pressurized drive fluid circulates in a closed loop from the compressor to the cylinder.

In still another aspect, the invention relates to a method for generating power. The method preferably includes delivering a pressurized drive fluid to a drive engine from a pressure source, operating the drive engine under the influence of the pressurized drive fluid to drive an output of the drive engine, and at least partially charging the pressure source from the output of the drive engine.

In another aspect, the invention relates to a retrofit kit for converting an internal combustion engine into a fluid-driven engine. The retrofit kit preferably includes a compressor for pressurizing a working fluid to a working pressure for delivery to a cylinder of the engine, a solenoid operated valve for controlling the delivery of the working fluid to the cylinder of the engine, and drive means for energizing the compressor.

In another aspect, the invention relates to a fluid-driven motor system. The system preferably includes an engine block having at least one piston reciprocally mounted therein, at least one crankshaft driven by the piston(s), and a source of pressurized air or other drive fluid. The pressurized drive fluid is delivered through a port of each cylinder head in the engine block to drive the piston through reciprocating strokes and turn the crankshaft. The system optionally also includes an air rail having a plurality of air injector electric switches to connect each engine block port to the pressurized air supply through a plurality of pipe or conduit connections, wherein the air rail has a high pressure inlet side and a lower pressure return or exhaust side.

In another aspect, the invention relates to a method for modifying an internal combustion engine block preferably comprising at least one piston, at least one crankshaft, at least one cylinder head, at least one intake manifold having at least one control hole, at least one exhaust manifold having at least one emission control port, at least one spark plug in at least one port, at least one drive belt, a distributor, a timing chain, cam timing and a carburetor. The method preferably includes the steps of removing the spark plugs from the spark plug ports and plugging each spark plug port; mounting an air rail and air injector electric switch assembly to the spark plug ports, wherein the air rail has a plurality of electric solenoids; attaching a plurality of electrical connections from the distributor to the air rail electric solenoids; setting the crankshaft timing to top dead center; removing the carburetor; adding a breather air filter; closing intake manifold control holes; closing exhaust manifold emission control ports; installing an alternator and an external belt driven air compressor to the engine block and adjusting the drive belts; and connecting a pressurized air supply vessel to the air rail, wherein the connection comprises at least one air pressure line and at least one air return line.

In still another aspect, the invention relates to a fluid driven motor system. The system preferably includes a source of pressurized drive fluid; at least one cylinder having a piston therein for reciprocating motion, the cylinder receiving the pressurized drive fluid from the source; and a compressor receiving drive fluid exhausted from the at least one cylinder. The pressurized drive fluid circulates in a closed loop from the compressor to the cylinder.

In another aspect, the invention relates to a kit for retrofit adaptation of an internal combustion engine to operate on pressurized air or other drive fluid. The retrofit kit preferably comprises an electrical motor driving a compressor to pressurize the drive fluid, solenoids or valves for controlled delivery of the pressurized drive fluid to and from cylinders of the engine to drive its pistons, and computerized control means for operating the solenoids of valves in timed sequence to operate the motor. Optionally, the electrical motor is driven by batteries that are partially or fully charged by an alternator or generator driven by the engine, and/or by a solar panel. Also optionally, the compressor is alternately driven by the engine and/or by the electrical motor through controlled engagement and disengagement of a clutch mechanism.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 is a schematic diagram showing fluid flow and drive features of a first embodiment of a pneumatic engine and drive system according to an example form of the present invention.

FIG. 2 is a schematic diagram showing fluid flow and drive features of a second embodiment of a pneumatic engine and drive system according to an example form of the present invention.

FIG. 3 is a first perspective view of a modified internal combustion engine according to an example form of the present invention.

FIG. 4 is a second perspective view of the modified internal combustion engine of FIG. 3.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

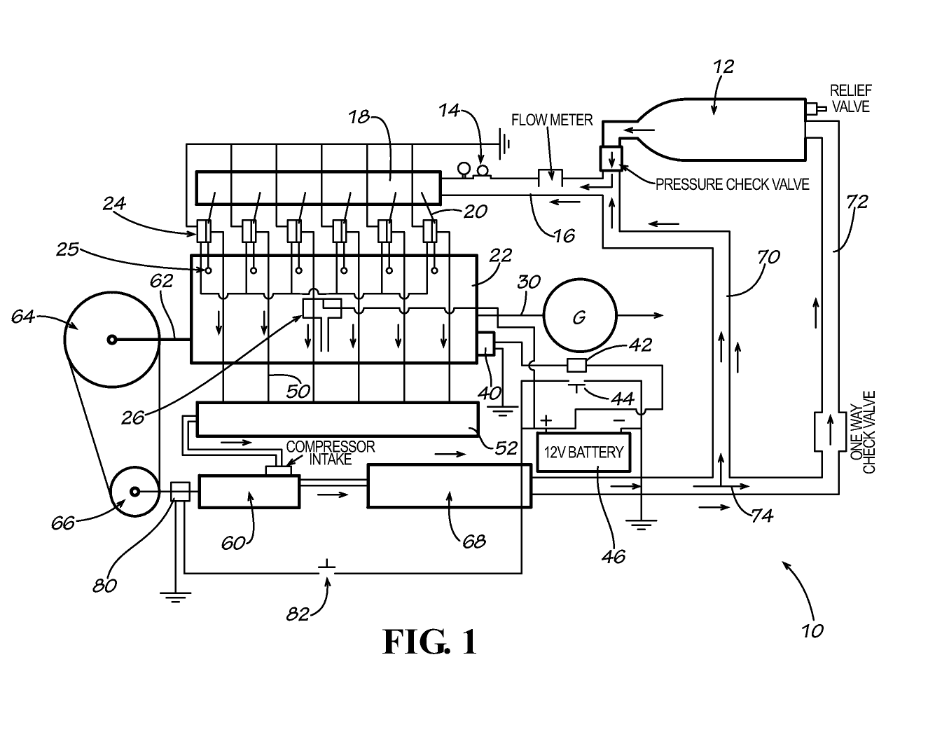

FIG. 1 shows a pneumatic drive motor system 10 according to an example form of the invention. Pressurized air or other high-pressure drive fluid is delivered from the pressure boost tank 12, or alternatively from a compressor or other high-pressure drive fluid source, at a pressure designated the “supply” or “high” pressure. A pressure regulator 14 in the high pressure fluid supply line 16 maintains the delivery pressure and flow within specified parameters. The high-pressure drive fluid is delivered to the intake or supply manifold 18, where it is distributed to one or more supply side pressure air lines 20. In the depicted embodiment, the pneumatic drive motor is a modified six-cylinder internal combustion engine 22 having six pistons reciprocatingly mounted within cylinders in the engine block, and the supply manifold 18 distributes high-pressure drive fluid to six supply side pressure air lines 20. In alternate embodiments, single-cylinder, two-cylinder, four-cylinder, eight-cylinder, ten-cylinder, twelve-cylinder, and other arrangements are within the scope of the invention.

The supply side pressure air lines 20 deliver high-pressure drive fluid to the cylinders of the pneumatic drive motor 22 in a delivery sequence controlled by air solenoid injectors 24. Optionally, an electronic timing device 26 such as a programmed computer controls the actuation sequence of the air solenoid injectors to open and close in a specified sequence to drive the pistons and thereby turn the crankshaft of the engine according to a two-stroke or four-stroke cycle, and output rotational drive power to the engine's driveshaft 30. A starter subassembly is optionally provided, comprising an electrical starter motor 40, starter solenoid 42, starter switch 44 and battery 46, for initiating the operation of the drive motor in similar fashion to that of starting an internal combustion engine of an automobile. The high-pressure drive fluid introduced to the cylinders of the pneumatic drive motor drives the pistons within the cylinders in similar fashion to that of the combustion gasses driving the cylinders of a standard internal combustion driven motor. The driveshaft output can be used to power an electrical generator G, to drive the drive-train of an automobile or other vehicle, or for various other uses.

The drive fluid is discharged from the cylinders of the pneumatic drive motor 22 via one or more exhaust or return air lines 50, and collected in an exhaust pressure return manifold 52. The discharged drive fluid has a reduced pressure (designated the “exhaust” or “low” pressure) relative to the higher supply pressure, due to energy extracted to drive the pistons of the drive motor. The exhausted drive fluid is delivered from the exhaust manifold 52 to a compressor 60. A secondary drive shaft or power take off shaft 62 coupled to the output-power drive shaft of the motor 22 drives the compressor 60, optionally via a crank pulley 64 and compressor pulley 66 drive mechanism, with the diameter ratio of the crank and compressor pulleys selected to deliver the necessary power to the compressor necessary to raise the pressure of the air or other drive fluid from the lower exhaust pressure back to the higher supply pressure. An oil and air separator 68 optionally is provided to remove any oil suspended in the pressurized drive fluid delivered from the compressor. The pressurized drive fluid is then recirculated back to the supply side of the motor system and into the supply manifold 18 via a primary circulation line 70, or alternatively is directed back to the pressure boost tank 12 via a secondary or bypass circulation line 72. Optionally, a three-way valve 74 is provided to control the circulation of the pressurized drive fluid to the primary circulation line 70 or the bypass circulation line 72.

A clutch 80 is optionally controlled by the controller 26 via a switch 82 to operate the compressor on demand, as needed to pressurize the drive fluid. Optionally, a secondary drive source such as an electrical drive motor (unshown) may drive the compressor in addition to the secondary drive shaft 62 to provide make-up pressurization, and/or allow the pressure boost tank 12 to be switched off by closing a control valve and taken out of the fluid cycle. Electrical power to drive the electrical drive motor may be delivered from one or more batteries, the power grid, solar panels, wind turbine power generation and/or other source(s).

Because the drive fluid is recirculated through a closed loop—from the supply side, through the motor, to the exhaust side, repressurized, and returned to the supply side—rather than discharging the exhaust to the atmosphere, the system of the present invention is highly efficient, both in terms of its fuel usage and its emissions. If renewable energy sources are used to pressurize the drive fluid, the system of the present invention may be operated without the need for hydrocarbon based fuels, and have very low or even no emissions. Depending upon factors including: the efficiencies of the various components; the amount of energy drawn from the motor system to drive the generator, vehicle or other application to which the system is applied; the relative pressures of the supply and exhaust sides of the system; the capacity of the pressure boost tank; the flow rate of the drive fluid; the electrical power source, and/or the length of time the motor is to be operated, the system may be self-sustaining or require only periodic recharging.

Various components and subassemblies are suitable for use in the motor system 10 of the present invention. In example forms, the pressurized air supply vessel 12 is capable of containing drive fluid of up to and about 3500 psi pressurized air and is tapped with a ½″ ID (inside diameter) pressure port and a ½″ ID return air port, and one or more pressure relief or “pop off” valves set to release or pop off at factory settings of between 200 psi and 350 psi in example forms. The air injector solenoids 24 are coupled to the air rail manifold 18 and fitted in a parallel configuration to feed drive fluid through supply lines to each spark plug port 25 of the drive motor 22.

The solenoids 24 are optionally 3-way solenoids that route supply fluid to the motor in a first stage, and then are switched to shut off the supply flow and allow exhaust fluid to discharge out of the same port 25 of the drive motor to the exhaust manifold 52 via the return air lines 50 in a second stage. Alternatively, output or return air lines connect between separate exhaust ports of the motor cylinders to the return manifold. The pipe connections are, for example, ½″ ID flexible high-pressure hose, stainless steel tubing, or other form of conduit. Air pressure regulator valves, sensors and/or gauges are optionally provided for controlling and monitoring the pressures at various stages within the system. An air dryer is optionally included to separate moisture formed by the air compression process, and can for example be mounted on the return air side of the pressurized air supply vessel.

The drive motor 22 can comprise a modified standard automotive-type engine having an engine block with cylinders, valves, pistons, a crankshaft and other components in typical fashion, for example taking the form of a six cylinder engine. The cylinder head assembly may be substantially similar to a standard automotive cylinder head assembly with modified intake and exhaust manifolds mounted thereon. In alternate forms, the engine block, cylinder heads and pistons may be specially fabricated and formed of aluminum, polymers and/or other lightweight materials, since there is no fuel combustion that would require high-temperature resistant materials. The motor system of the present invention can operate on a modified conventional four-stroke sequence, adjusting the timing of the cam shaft, modifying the distributor rotor, and with the addition of the solenoid air switches. Alternatively, the motor system operates on a modified two-stroke sequence. In further forms of operation, the motor initially starts using a two-stroke cycle, and then switches to a four-stroke cycle. Pressurized drive fluid is delivered to each cylinder in a controlled sequence to drive the cylinder's piston down (the power stroke), thus rotating the crank shaft. In the exhaust stroke, as the subsequent cylinder upstroke begins, the air injector electric solenoid switch closes, and exhaust returns through the three-way solenoid allowing pressurized air to be exhausted from each cylinder to the exhaust manifold 52 and returned to the intake of the air compressor 60.

The electric timing device or controller 26 may comprise, for example an automotive-type rotor distributor, modified with a spring mounted on its outer contact to enhance twelve-volt electrical connection with distributor cap conductors as it makes contact. The coil is optionally removed from the distributor circuit, as fuel ignition is not required in the system of the present invention. The timing device actuates the solenoids in a specified sequence to control operation of the motor. Alternatively, a programmed computer or microprocessor based controller may be utilized. The controller supplies low voltage electric current to open and close the air injector solenoids 24 in the proper sequence. As note above, if an automotive distributor is used, the coil can be removed to maintain low voltage delivery to the distributor, thereby protecting the solenoids in the air injector electric switches, and the distributor's internal rotor can be modified with a metallic spring to enhance the electrical connection to each of the distributor cap's contacts. As the spring on the distributor's rotor makes contact over the distributor's conductors, electric power can be transferred through electric wires to the respective air switches 24 for opening and closing. The timing can be changed from a four-cycle to a two-cycle operation, by way of energizing corresponding cylinder solenoids in the proper sequence on every power stroke. Timing can be accomplished by energizing solenoids 1 and 6, then 2 and 5, then 3 and 4, and so on. A voltage regulator and twelve volt (12V) automotive battery charged by a standard automotive electric alternator can complete the electrical system for the electrical system for the example embodiment. In an alternative method of timing the opening and closing of the air switches 24, an electronic programmable semiconductor timing circuit powered by low voltage is provided.

One or more pressure relief valves within the system prevent over-pressurization, for example, fitted before and after the pressurized air supply vessel 12, in the air pressure supply and air return lines, and/or in the high pressure drive fluid conduits. One-way check valves are optionally provided in the air pressure lines, the air return lines, and/or in the high pressure drive fluid conduits, to prevent pressurized air from reversing flow direction and creating back pressure and drag in the system. An air dryer is optionally included in the pneumatic system to reduce moisture produced by the compressed air. An air pressure regulator 14 is optionally mounted on or adjacent the air rail 18 to set and maintain optimum regulated system pressure. The compressor 60 may, for example, take the form of an external belt-driven air compressor driven by the crankshaft of the motor to replenish sufficient air pressure to working fluid driving the motor 22.

A variable manual pressure regulator can optionally be substituted for the pressure regulator described above. Fitted with a floor pedal, the variable manual pressure regulator can function as a “throttle” in an automotive application to increase or decrease motor revolutions by increasing or decreasing the air pressure to the cylinders. A range of automotive engines can be modified according to the present invention to achieve different power outputs including for example two (2), four (4), six (6), eight (8), ten (10) and twelve (12) cylinder engine configurations. The cylinder count and displacement can be directly proportional to power output of the pneumatic drive motor system providing a range of applications from automotive transportation to constant speed pump or electric generator drives. Diesel engines may be modified according to the invention to provide increased power output due to their larger cylinder displacement. Each manifold of the engine can be modified as described below.

Standard automotive engine components can be prepared and modified for conversion to the pneumatic drive motor by providing a retrofit kit for carrying out the modifications according to the present invention. The kit can include a distributor modified by mounting an enlarged conductive metallic spring to the rotor end to provide longer contact with conductors on distributor cap, or the components to modify an automotive distributor in like manner. The standard automotive intake and exhaust manifold can be removed and replaced with the high pressure manifold 18 and exhaust pressure manifold 52, as described, which are also optionally included in the retrofit kit. The air solenoid injectors 24 are optionally included in the kit, along with tubing and/or other conduit and connectors for piping the solenoids into communication with the respective spark plug ports of the engine block. The exhaust sides of the solenoids are connected via return pressure air lines to the exhaust pressure manifold 52, also optionally included in the kit. A pressurized air supply vessel 12 is optionally included, along with piping and connectors for the drive fluid circuit.

An assembly method for modifying an engine according to the present invention includes connection of the high pressure manifold or air rail 18 via the pressure air lines 20 to the air injector electric solenoids 24, and connection of the air injector solenoids to the spark plug ports of the engine block. The electrical connections from the modified distributor or controller 26 are connected to the air solenoid injectors 24. The crankshaft timing is set to just past “top dead center”. The alternator and external belt driven air compressor 60 are installed to engine block 22, and the drive belts are installed and adjusted. The air pressure lines, emergency pressure valve(s), and one-way check valve(s) from the air rail manual pressure regulator are connected to the outlet/pressure side of the pressurized air supply vessel 12. Likewise, the air return lines 50 from the three way solenoids 24 are connected to the return air rail or exhaust pressure manifold 52, and the output of the manifold is routed to the intake of the external belt driven air compressor 60. A one-way check valve, emergency pressure relief valve(s) and an air dryer are optionally added to the return air line. The battery 46, starter solenoid 42, start switch 44, and engine starter motor circuit 40 are connected.

To start the engine, the pressurized air supply vessel 12 is charged to about 200 PSI. An external compressor can be used for this purpose. The manual pressure regulator 14 is adjusted to about 150 PSI. The starter is engaged, the pressurized drive fluid is released from the supply tank 12, the timing device actuates the solenoids to deliver fluid to the cylinders in the proper sequence, the pistons begin turning the motor, the compressor clutch is engaged, and the drive fluid is circulated to continue the motor's operation. Operating pressure is maintained by the compressor and/or by periodic release from the pressure tank 12.

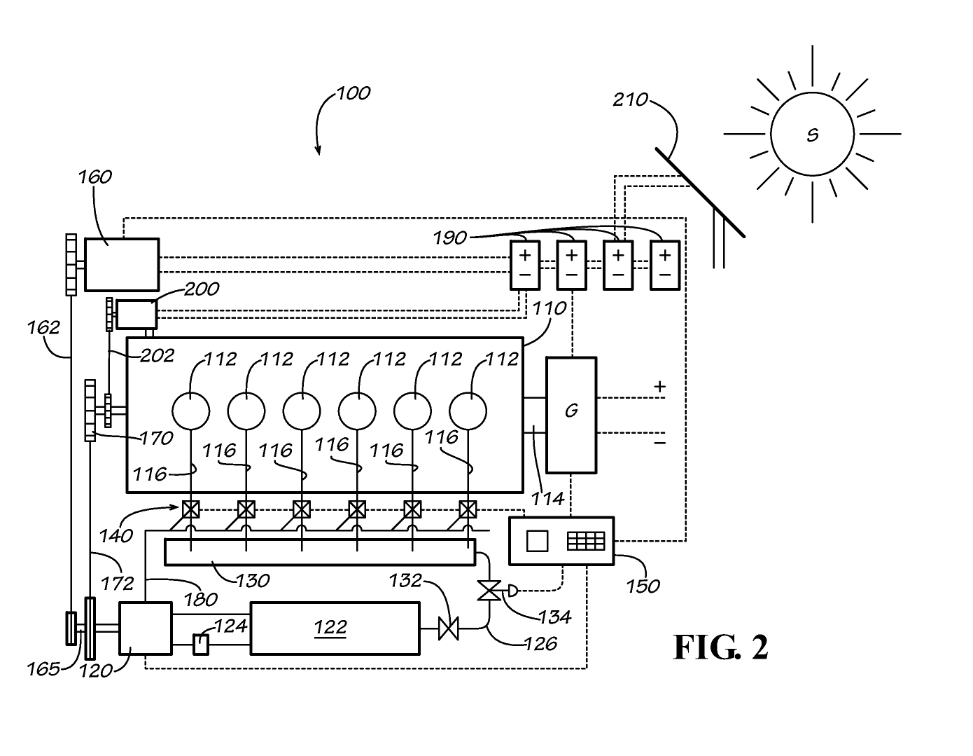

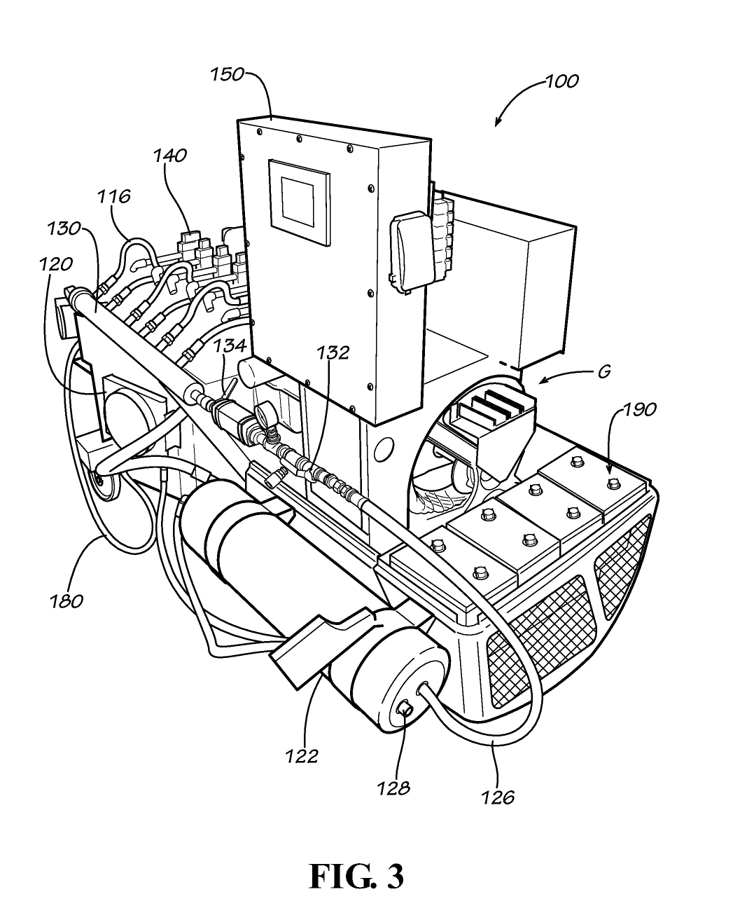

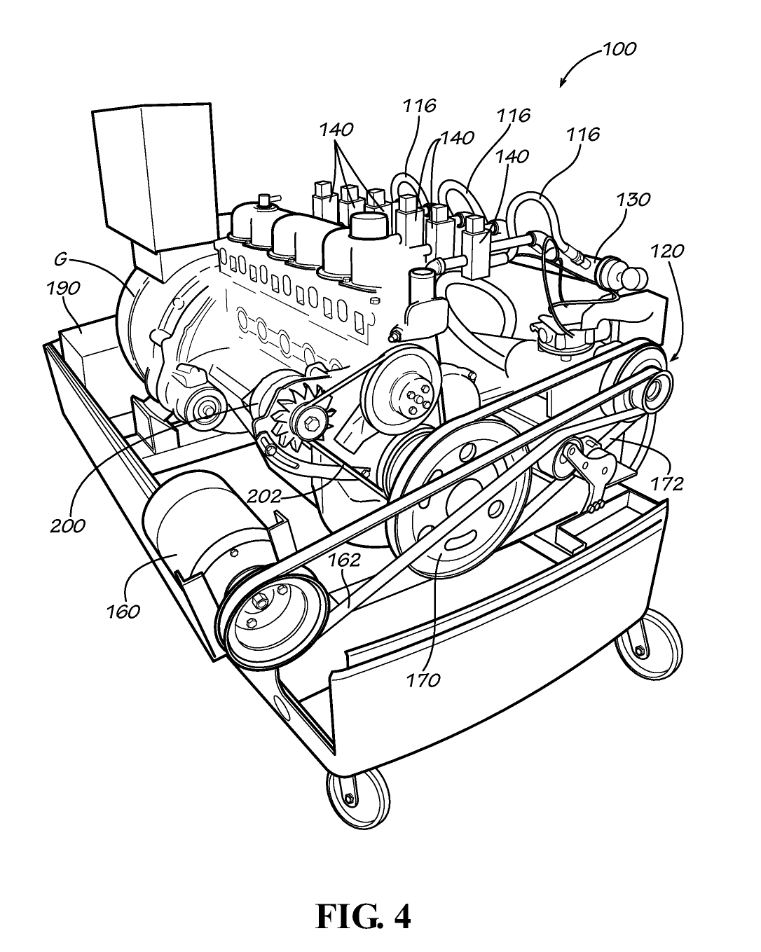

FIGS. 2-4 show a second embodiment of a pneumatic drive motor system 100 according to another example form of the invention. An engine 110, such as a FORD inline-6 240CC engine, having an engine block with six pistons 112 reciprocating in its cylinders, coupled to a crankshaft by connecting rods, drives a driveshaft 114 to drive a power generator G or other equipment such as for example the drive train of an automobile or other vehicle, a pump, etc., in typical fashion. In example form, a 60 kW ONAN electrical generator is connected to the engine output to generate electrical power such as 110V/60 Hz A/C power. High pressure compressed air, inert gas, water, hydraulic fluid or other liquid or gaseous drive fluid is delivered via inlet line fluid conduits 116 to drive the pistons in a two-stroke and/or four-stroke cycle. The drive fluid is delivered to the engine cylinders through the spark plug port of each cylinder, with the intake and exhaust valves seated and disabled. In alternate forms, a customized cylinder head plate is provided, having a ported head plate with inlet ports oriented to direct the drive fluid downward onto the pistons, parallel with the axis of the cylinder and the direction of reciprocal motion of the piston. In alternate embodiments of the invention, because the high temperatures of combustion gasses are not present, the engine 110 may include engine block, piston and/or other components comprising polyethylene or other polymeric materials, lightweight aluminum, composite or other low operating temperature materials, thereby reducing weight and manufacturing expense, as compared to iron or steel engine components.

The working fluid is pressurized by a compressor 120, delivered to a high pressure inlet manifold 130, and distributed from the manifold to the engine inlets 116 under the control of electronically switched solenoid valves 140, such as for example 12V plunger solenoids. In example form, the compressor 120 may comprise a 45 horsepower high-volume hydraulic rotary screw air compressor, such as a VMAC VR140 vehicle mounted air compressor. An oil/water separator and hydraulic oil reservoir 122 and an oil cooler 124 are optionally provided in the working fluid conduit 126 between the discharge of the compressor and the inlet manifold 130. The oil/water separator and hydraulic oil reservoir 122 optionally includes a pop-off or pressure relieve valve 128 set to release at about 200 psi. A purge valve 132 and a control valve 134 are optionally provided in the fluid conduit 126 for pressurization and control of the delivery of working fluid to the inlet manifold 130. Optionally, a pressure boost tank (unshown) may be connected to the working fluid conduit to deliver pressurized working fluid to supplement or replace the compressor as a source of high-pressure inlet working fluid.

Operation of the compressor 120, the purge valve 132, the control valve 134, and/or the solenoid valves 140, as well as other components described below, can be controlled by an onboard or remote electronic control system. The control system comprises a programmed computer 150 or microprocessor with software installed thereon, connector wiring (shown in broken lines in FIG. 2), and control sensors and actuators on the respective system components. For example, the distributor of the engine 110 is optionally linked to the computer 150 as a position sensor to indicate the stroke position of the pistons for timing the delivery and discharge of the working fluid. The computer 150 preferably comprises an input device such as a keyboard or touchscreen and an output device such as a display and/or indicator lights for controlling and displaying the operating parameters of the system.

The compressor 120 is alternatively driven by an electric drive motor 160 and/or the crankshaft pulley 170 of the engine 110, via first and second pulley and drive belt systems 162, 172, respectively. In example form, the electric drive motor 160 comprises a 25 horsepower, 48V DC, CROWN model no. W7AA01 8.4/10.5 kW electric motor. The ratio of pulley diameters in the first and second pulley and drive belt systems 162, 172, are selected to deliver a specified operating power to the compressor. For example, a 2:1 ratio may be provided by a 7″ pulley on the motor 160 coupled by belt to a 3½″ pulley on the driveshaft of the compressor 120; and a 13″ crankshaft pulley may be coupled by belt to a 7″ pulley on the compressor shaft. An electronically switched clutch 165 may be provided to control application of power to the driveshaft of the compressor 120 from the motor 160 and/or the crankshaft pulley 170.

Reduced-pressure working fluid exhausted from the engine cylinders on the upstroke or return stroke of the pistons is ported via the solenoid valves 140 to a return conduit 180 and delivered back to the inlet of the compressor 120 as a ram-air intake delivery. Because the exhaust fluid is typically at a higher pressure than the atmosphere, less power is required from the compressor to bring the working fluid back up to the working inlet pressure than ambient intake air, and the suction of the compressor inlet may assist in pulling the exhaust fluid from the return conduit and cylinders to provide improved efficiency. In alternate forms, the exhaust fluid is discharged to the atmosphere, and the compressor inlet draws in entirely fresh filtered intake air from the ambient surroundings.

The electric drive motor 160 is powered by one or more batteries 190, and/or other power source(s). In the depicted embodiment, four 12V deep-cycle marine type batteries are connected in parallel to provide a 48V output to drive the motor 160. An alternator or generator 200 is optionally coupled by a belt and pulley drive 202 to a crankshaft pulley of the engine, and electrically connected to charge the batteries 190. Alternatively or additionally, a solar panel 210 is provided to collect solar energy from the sun S or other light source and convert it to electrical power to charge the batteries 190. In alternate embodiments, a wind-power turbine or other renewable, natural and/or free energy source(s) is/are utilized in place of or in addition to the solar panel to charge the batteries 190.

In operation, the compressor 120 is initially started under power of the electric drive motor 160, which is in turn powered by the batteries 190 and/or the solar panel 210. In example forms of operation, the compressor is purged at about 2200 revolutions per minute (rpm) for about 15 seconds to develop a working pressure of about 180-200 pounds per square inch (psi) in the air or other working fluid, and then reduced to about 800-1100 rpm to maintain a working delivery pressure of about 180-200 psi at a delivery rate of about 150-250 cubic feet per minute (cfm). The computer 150 controls actuation of the purge valve 132 and the control valve 134 based on pressure sensed in the working fluid conduit 126 as the compressor is purged and transitioned to normal operating speed. An electric starter motor starts the engine 110 turning.

Once working pressure has been reached, the computer 150 controls operation of the solenoid valves to deliver pressurized working fluid to and from the inlet ports of the cylinders of engine 110 to drive the engine's pistons in a predetermined two-stroke or four-stroke sequence, and optionally switches the operating cycle between two-stroke and four-stroke operation depending on the desired operating rpm speed and/or power output. The sequence of actuation and timing of pistons 1 through 6 in two-stroke operation is: cylinders 1 and 6 at 0° past top-dead-center, cylinders 2 and 5 at 60° past top-dead-center, cylinders 3 and 4 at 120° past top-dead-center, cylinders 1 and 6 at 180° past top-dead-center, cylinders 2 and 5 at 240° past top-dead-center, and cylinders 3 and 4 at 300° past top-dead-center, two cylinders firing at a time. The sequence of actuation and timing of pistons 1 through 6 in four-stroke operation is: cylinder 1 at 5° past top-dead-center, cylinder 5 at 60° past top-dead-center, cylinder 3 at 120° past top-dead-center, cylinder 6 at 180° past top-dead-center, cylinder 2 at 240° past top-dead-center, and cylinder 4 at 300° past top-dead-center, one cylinder firing at a time. A sensor head is connected to the rotor rod of the engine's distributor (which turns with the camshaft of the engine). A positional sensor in the sensor head sends a signal to the computer controller 150 indicating the timing position (corresponding to the degrees of rotation past top-dead-center), allowing the computer to control opening and closing of the solenoid valves 140 in the desired sequence and timing. The timing is optionally initiated slightly past top-dead-center so that the cylinders are pressurized just after the piston starts its downstroke, to avoid generating back-pressure at the end of the piston's upstroke. The solenoid valves are opened to allow free exhaust of the driving fluid on the piston upstroke, also to avoid developing back-pressure in the cylinders.

The pistons turn the engine to drive the crankshaft and in turn the driveshaft output of the engine to drive the generator, drive train or other powered equipment. In example forms of operation, the engine turns at between about 900-2200 rpm, with the speed being controlled by the computer 150 based on user input, via operation of the control valve 134 and control of the solenoids 140. The speed of the engine (rpm) can be varied by operation of the control valve 134 to adjust the airflow (cfm) to the supply rail 130. The horsepower or torque delivered by the engine can be varied by control of the duration of time during which the solenoid valves 140 are opened to pressurize the cylinders from the supply rail, which adjusts the pressure applied to the pistons.

Upon reaching a predefined operating speed, the clutch 165 is operated under control of the computer 150 to engage the compressor drive from the crankshaft pulley 170, which in turn is driven by the engine 110, and to disengage the compressor drive from the electric drive motor 160. The electric drive motor 160 is then de-energized so as not to draw power from the batteries. Optionally, the electric drive motor may continue to be driven by the crankshaft pulley 170 through the clutch, and act as a reverse-motor generator to recharge the batteries 190. Additionally or alternatively the alternator 200, the generator G, and/or the solar panel operate to recharge the batteries 190 under the control of computer 150.

When the pressure of the working fluid delivered by the compressor drops below a predefined threshold minimum working pressure, the computer 150 re-engages the electric drive motor 160 and switches the clutch 165 to drive the compressor from the electric drive motor in order to bring the working pressure back up. Upon reaching a predefined maximum working pressure, the clutch disengages the electric drive motor 160, and the electric drive motor is deactivated. The engine continues to operate in this manner, with the compressor 120 driven by the engine 110 and periodically supplemented as needed by the electric drive motor 160 to maintain desired operation. Because the electric drive motor 160 only draws power from the batteries 190 periodically, the battery charge may be very long lasting. Recharging of the batteries as described, optionally supplemented by solar or other renewable energy, results in a highly efficient, low emission, and long lasting source of power.

While the invention has been described with reference to preferred and example embodiments, it will be understood by those skilled in the art that a variety of modifications, additions and deletions are within the scope of the invention, as defined by the following claims.

What is claimed is:

1. A fluid driven motor system comprising:
an engine having at least one reciprocating piston and an intake port for delivery of a pressurized working fluid to drive the piston;
a source of the pressurized working fluid connected to the intake port of the engine; and
an output of the engine driven by operation of the at least one reciprocating piston and delivering energy to the source to pressurize the pressurized working fluid.

2. The fluid driven motor system of claim 1, wherein the source of the pressurized working fluid comprises a compressor, and the output of the engine comprises a crankshaft of the engine, wherein the compressor is at least partially driven by the crankshaft.

3. The fluid driven motor system of claim 2, wherein the compressor comprises a rotary screw air compressor.

4. The fluid driven motor system of claim 2, further comprising an electric motor, and wherein the compressor is at least partially driven by the electric motor.

5. The fluid driven motor system of claim 4, further comprising a clutch for engaging and disengaging the electric motor from driving the compressor.

6. The fluid driven motor system of claim 5, further comprising a renewable power source for powering the electric motor.

7. The fluid driven motor system of claim 5, further comprising computer control means for controlling the operation of the clutch.

8. The fluid driven motor system of claim 1, further comprising a solenoid valve controlling delivery of a pressurized working fluid to the intake port.

9. The fluid driven motor system of claim 1, further comprising an electrical power generator coupled to a drive shaft of the engine.

10. The fluid driven motor system of claim 1, wherein the source of the pressurized working fluid comprises a pressure tank.

11. The fluid driven motor system of claim 10, wherein the output of the engine comprises an exhaust flow of the pressurized working fluid discharged from the engine.

12. The fluid driven motor system of claim 1, further comprising a supply manifold for delivery of the pressurized working fluid to the intake port of the engine.

13. A fluid driven motor system comprising:
an engine comprising at least one cylinder, a piston reciprocally mounted within each cylinder, a working fluid intake port in communication with each cylinder, and at least one power output;
a compressor for pressurizing a working fluid, the compressor at least partially driven by the at least one power output of the engine;
an intake manifold receiving the pressurized working fluid;
a solenoid valve controlling delivery of the pressurized working fluid from the intake manifold to each cylinder; and
an electric motor for driving the compressor.

14. The fluid driven motor system of claim 13, further comprising computer control means for operating the solenoid valve to control delivery of the pressurized working fluid.

15. The fluid driven motor system of claim 13, further comprising control means for alternatively driving the compressor from at least one of the electric motor and the power output of the engine.

16. The fluid driven motor system of claim 15, further comprising computer control means for actuating the control means to drive the compressor from the electric motor when the pressurized working fluid drops below a threshold minimum pressure.

17. The fluid driven motor system of claim 13, further comprising a battery to power the electric motor.

18. The fluid driven motor system of claim 17, further comprising a solar panel for charging the battery.

19. The fluid driven motor system of claim 13, further comprising an electrical power generator coupled to the at least one power output of the engine.

20. A fluid driven motor system comprising:
a source of pressurized drive fluid;
at least one cylinder having a piston therein for reciprocating motion, the cylinder receiving the pressurized drive fluid from the source; and
a compressor receiving drive fluid exhausted from the at least one cylinder;
wherein the pressurized drive fluid circulates in a closed loop from the compressor to the cylinder.

21. The fluid driven motor system of claim 20, further comprising at least one three-way solenoid valves that controls the delivery and exhaust of the pressurized drive fluid from the cylinder.

22. The fluid driven motor system of claim 20, wherein the compressor is driven by the operation of the at least one cylinder via a crankshaft.

23. The fluid driven motor system of claim 20, further comprising a generator driven by the operation of the at least one cylinder via a drive shaft.

24. A method for generating power, said method comprising:
delivering a pressurized drive fluid to a drive engine from a pressure source;
operating the drive engine under the influence of the pressurized drive fluid to drive an output of the drive engine; and
at least partially charging the pressure source from the output of the drive engine.

25. The method of claim 24, wherein the pressure source is a compressor, and the output of the drive engine is a crankshaft output operatively coupled to the compressor.

26. The method of claim 24, wherein the pressure source is a pressure tank, and the output of the drive engine is an exhaust flow of the pressurized drive fluid discharged from the engine.

27. A retrofit kit for converting an internal combustion engine into a fluid-driven engine, the retrofit kit comprising:
a compressor for pressurizing a working fluid to a working pressure for delivery to a cylinder of the engine;
a solenoid operated valve for controlling the delivery of the working fluid to the cylinder of the engine; and
drive means for energizing the compressor.

28. The retrofit kit of claim 27, wherein the drive means for energizing the compressor comprises an electric motor.

29. The retrofit kit of claim 28, further comprising a solar panel.

30. The retrofit kit of claim 27, further comprising computer control means for operating the compressor and the solenoid operated valve.
